(19) United States
(12) Patent Application Publication
(10) Pub. No.: US 2019/0295461 A1
(43) Pub. Date: Sep. 26, 2019

(54) DISPLAY PANEL AND TERMINAL

(71) Applicant: Yungu (Gu'an) Technology Co., Ltd., Langfang (CN)

(72) Inventors: Xiaokang ZHOU, Kunshan (CN); Mengzhen LI, Kunshan (CN); Hui PANG, Kunshan (CN); Yangjie ZHU, Kunshan (CN); Hailong XU, Kunshan (CN)

(73) Assignee: Yungu (Gu'an) Technology Co., Ltd., Langfang (CN)

(21) Appl. No.: 16/441,552

(22) Filed: Jun. 14, 2019

Related U.S. Application Data
(63) Continuation of application No. PCT/CN2018/091229, filed on Jun. 14, 2018.

(30) Foreign Application Priority Data
Oct. 31, 2017 (CN) 201711047036.5

(51) Int. Cl. G09G 3/32

(52) U.S. Cl. CPC G09G 3/32; G09G 2320/0233

(57) ABSTRACT

A display panel and a terminal are provided. The display panel includes a light-emitting module, and scanning lines, data lines, and power lines which are electrically connected to the light-emitting module. Each of the power lines extends along a short side direction of the display panel, a number of power lines are arranged spaced apart along a long side direction of the display panel.

### CROSS-REFERENCE TO RELATED APPLICATION

This application is a continuation of International application No. PCT/CN2018/091229, filed on Jun. 14, 2018, which is based upon and claims priority to Chinese Patent Application No. 201711047036.5, filed on Oct. 31, 2017, with a title “DISPLAY PANEL AND TERMINAL”, the entire contents of which are hereby incorporated by reference.

### TECHNICAL FIELD

The application relates to a display technical field, and more particularly to a display panel and a terminal.

### BACKGROUND

In recent years, display technology has developed rapidly, and display panels have been applied to various electronic and electrical devices. The display panel includes a plurality of scanning lines SSL, a plurality of data lines DataL, a plurality of power lines DDL, and a light-emitting module. The plurality of scanning lines SSL intersect with the plurality of data lines DataL and the plurality of power lines DDL, to define sub-pixel regions with various colors for displaying a picture. In the display panel, the power line itself has a large resistance, so that the resistance voltage drop is large, and each sub-pixel area is unevenly displayed.

### SUMMARY

The object of the application is to provide a display panel, to improve the problem of display unevenness due to the resistance voltage drop of the power line.

The application also provides a terminal including the above display panel.

In order to achieve the above object, the application adopts the following technical solution.

A display panel includes: a light-emitting module, one or more scanning lines, one or more data lines, and one or more power lines electrically connected to the light-emitting module, each of the power lines extending along a short side direction of the display panel, a plurality of power lines being arranged at intervals along a long side direction of the display panel.

Furthermore, each of the data lines extends along the short side direction of the display panel, the plurality of the data lines are arranged at intervals along the long side direction of the display panel.

Furthermore, each of the scanning lines extends along the long side direction of the display panel, the plurality of the scanning lines are arranged at intervals along the short side direction of the display panel.

Furthermore, the power lines and the data lines are arranged in a same layer and are insulated with each other.

Furthermore, a plurality of the power lines and a plurality of the data lines are alternately arranged at intervals.

Furthermore, a plurality of the scanning lines intersect with a plurality of the data lines and a plurality of the power lines to define sub-pixel regions of various colors, one data line and one power line are simultaneously arranged between the adjacent two sub-pixel regions.

Furthermore, the display panel includes a signal access part located at an edge of a long side of the display panel.

Furthermore, the display panel includes a signal access part, the display panel is a flexible display panel, the signal access part is located on a back of the display panel.

An terminal includes a housing and the above display panel arranged in the housing.

Each of the power lines of the display panel provided by the application extends along the short side direction of the display panel, which effectively shortens the length of the power line and improves the display unevenness caused by the resistance voltage drop on the power line.

### BRIEF DESCRIPTION OF THE DRAWINGS

The drawings described herein are intended to provide a further understanding of the application, and are intended to be a part of the application. The illustrative embodiments of the application and the description thereof are intended for explaining the application and do not constitute an undue limitation to the application. In the drawing:

FIG. 1 is a schematic view of a display panel provided by an embodiment of the application; and

FIG. 2 is a schematic view of a light-emitting module in a display panel provided by an embodiment of the application.

### DETAILED DESCRIPTION

In order to make the objects, the technical solution and the advantages of the application clearer, the technical solution of the application will be clearly and completely described in the following with reference to the specific embodiments of the application and the corresponding drawings. It is apparent that the described embodiments are merely a part of the embodiments of the application rather than all of them. All other embodiments obtained by a person skilled in the art based on the embodiments of the application without paying creative work fall into the protection scope of the application.

The directional terms mentioned in the application are merely directions to which accompany drawings are referred. Therefore, the directional terms used is for the purpose of illustrating and understanding, and is not intended to limit the application. The dimensions of each of the components shown in the drawings are arbitrarily shown for the sake of understanding and convenience of description, but the application is not limited thereto.

In addition, in the specification, unless explicitly described as the opposite, the word “comprising” is to be understood to include said components, but does not exclude any other components.

The technical solutions provided by preferred embodiments of the application are described in detail below with reference to the accompanying drawings.

The present embodiment provides a terminal (not shown in the Figures), including a housing (not shown) and a display panel 1 arranged in the housing. The terminal in the embodiment of the application may be a mobile phone, a tablet computer, a notebook computer, a PC, a television, and the like.

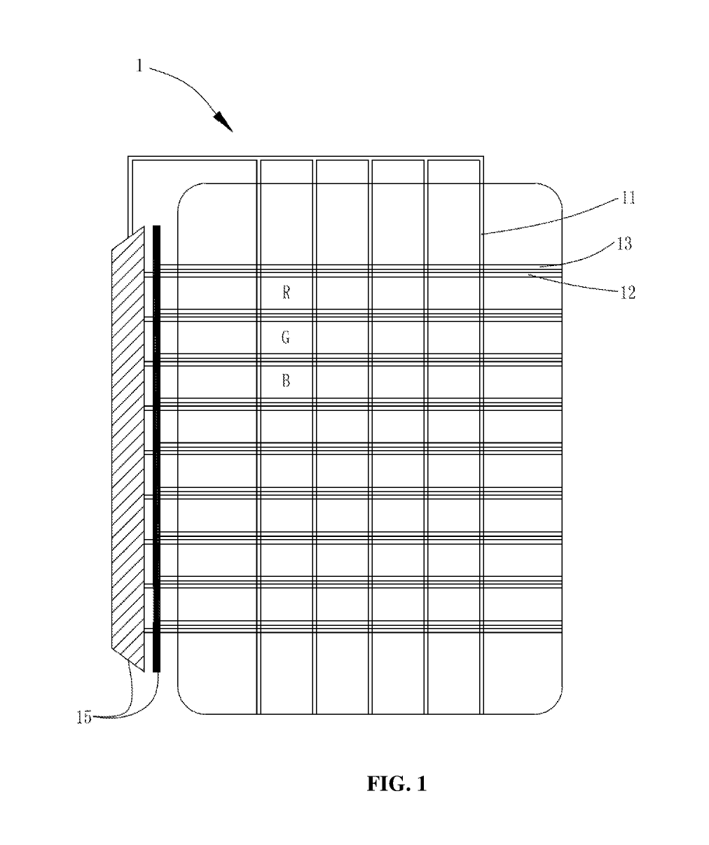

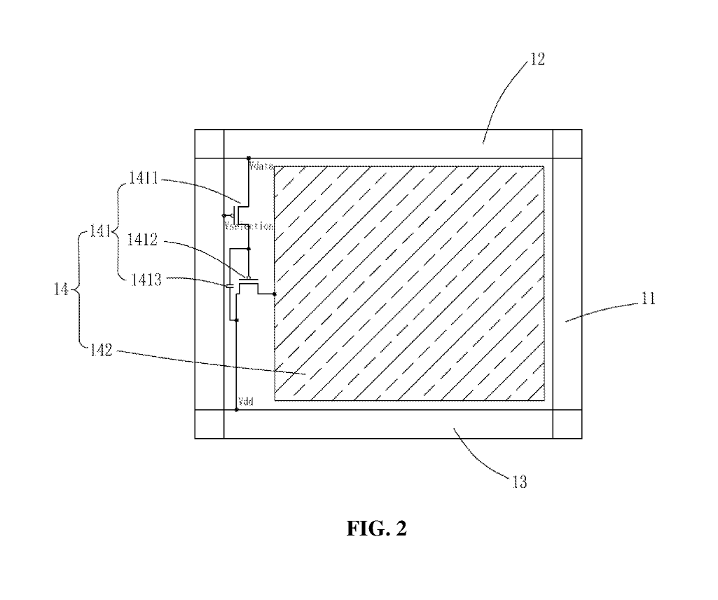

As shown in FIG. 1 and FIG. 2, a display panel 1 includes scanning lines 11, data lines 12, power lines 13, light-emitting modules 14 electrically connected to the scanning lines 11, the data lines 12, and the power lines 13. The display panel 1 further includes a signal access part 15 for accessing electrical signals. It should be noted that the number of scanning lines 11, data lines 12, and power lines 13 in FIG. 1 are labeled only for the schematic description, and are not equal to the actual number of lines.

A plurality of scanning lines 11 intersect with a plurality of data lines 12 and a plurality of power lines 13 to define sub-pixel regions with various colors. The light-emitting modules 14 are located in each of sub-pixel regions. In present embodiment, a plurality of scanning lines 11 intersect with a plurality of data lines 12 and a plurality of power lines 13 to define sub-pixel regions with three colors, a red sub-pixel region R, a green sub-pixel region G, and a blue sub-pixel region B respectively. Of course, in other embodiments, types, quantity of the colors, and arrangement manner of the sub-pixel region may be different from that of the present embodiment, and the application is not limited thereto.

As shown in FIG. 2, the light-emitting modules 14 in the present embodiment include a driving circuit structure 141 and a unit light-emitting device 142 driven by the driving circuit structure 141. The driving circuit structure 141 includes a switching transistor 1411, a driving transistor 1412, and a storage capacitor 1413.

In the present embodiment, the light-emitting modules 14 adopt a driving circuit structure 141 of 2T1C (T represents a thin film transistor, and C represents a storage capacitor), thus a followed connection manner between the scanning lines 11, the data lines 12, the power lines 13, and the switching transistor 1411, the driving transistor 1412, and the storage capacitor 1413 will be specifically described based on this structure. 2T1C in the present embodiment is merely a schematic illustration, the application is not limited to the circuit structure, and in actual applications, it may be other driving circuit structures which are more complicated, such as 6T1C, 7T1C or 6T2C, or the like.

The components of the display panel 1 of the present embodiment will be described in detail below with reference to the accompanying drawings.

As shown in FIG. 1 and FIG. 2, each of the scanning lines 11 extends along a long side of the display panel, and a plurality of scanning lines 11 are arranged at intervals along a short side of the display panel. The scanning lines 11 extend along the long side of the display panel, that is, the scanning lines 11 pass through both ends of the short side of the display panel. In the present embodiment, a metal material is selected for the scanning lines 11, but the application is not limited thereto. Conductive materials, such as an alloy, a nitride of a metal material, an oxide of a metal material, and a nitrogen oxide of a metal material or the like, may also be selected for the material of the scanning lines 11. The scanning lines 11 are electrically connected to a light-emitting module 14 in the sub-pixel region, to provide a gate voltage Vselection for the switching transistor 1411 connected thereto. Each scanning line 11 is also connected to a signal selector (not shown), and each scanning line 11 is connected to a shift register system (not shown) via the signal selector. The shift register system sequentially transmits strobe signals under the control of a system clock. After one scanning line 11 is gated, the switching transistors in the respective sub-pixel regions connected to the scanning line 11 are turned on.

Each of the data lines 12 extends along a short side of the display panel, and the plurality of the data lines 12 are arranged at intervals along a long side of the display panel. The data lines 12 extend along the short side of the display panel, that is, the data lines 12 pass through both ends of the long side of the display panel. In the present embodiment, a metal material is selected for the data line 12, but the application is not limited thereto. Conductive material, such as an alloy, a nitride of a metal material, an oxide of a metal material, and a nitrogen oxide of a metal material or the like, may also be selected for the material of the data line 12. The data line 12 on one side of each sub-pixel region is electrically connected to a light-emitting module 14 in the sub-pixel region, to provide a data signal Vdata to the switching transistor 1411 connected thereto. The data lines 12 are also connected to a signal access part 15, and access the electrical signal through the signal access part 15.

Each of the power lines 13 extends along a short side of the display panel, and the plurality of the power lines 13 are arranged at intervals along a long side of the display panel. The power lines 13 extend along the short side of the display panel, that is, the power lines 13 pass through both ends of the long side of the display panel.

In present embodiment, a metal material is selected for the power lines 13, but the application is not limited thereto. Conductive material, such as an alloy, a nitride of a metal material, an oxide of a metal material, and a nitrogen oxide of a metal material or the like, may also be selected for the material of the power line 13.

In the display panel, the plurality of the power lines 13 and the plurality of data lines 12 are formed in the same layer, and there is an insulating layer (not shown) between the plurality of the power lines 13 and the plurality of scanning lines 11. The power lines 13 on one side of each sub-pixel region are electrically connected to the light-emitting module 14 in the sub-pixel region, to provide a driving power signal Vdd to the driving transistor 1412 connected thereto. One end of the power lines 13 is connected to the signal access part 15, and the electrical signal is accessed through the signal access part 15.

In the present embodiment, the data lines 12 and the power lines 13 along the short side direction of the display panel, cross-arranged with the scanning lines 11 along the long side direction of the display panel allow the screen body to be normally displayed. A plurality of the power lines 13 extend along the short side direction of the display panel, and since the length along the short side of the display panel of the screen body is short, the length of the power line is short, thereby reducing the resistance voltage drop on the power line, greatly reducing the display unevenness caused by the resistance voltage drop on the power line, and greatly improving display quality of the screen body.

It should be understood that, in order to adapt to the existing wiring manner, in the present embodiment, a plurality of the data lines 12 are arranged to extend along the short side direction of the display panel and arranged at intervals along the long side direction of the display panel, being the same as the power lines 13. Meanwhile a number of scanning lines 11 are arranged to extend along the long side direction of the display panel and arranged at intervals along the short side direction of the display panel. The present application is not limited thereto. The arrangement of the plurality of scanning lines 11 and the plurality of data lines 12 may be different from the present embodiment, as long as the power lines 13 are arranged to extend along the short side direction of the display panel and arranged at intervals along the long side direction of the display panel.

At the same time, a plurality of scanning lines 11 intersect with a plurality of data lines 12 and a plurality of power lines 13, to define sub-pixel regions with various colors. One data line 12 and one power line 13 are simultaneously arranged between the adjacent two sub-pixel regions, and the power line 13 and data line 12 are insulated from each other. Some of the sub-pixel regions may be combined into a pixel region as needed. Specifically, in present embodiment, one red sub-pixel region R, one green sub-pixel region G, and one blue sub-pixel region B form one pixel region (for convenience of understanding, only one pixel region is labeled in FIG. 2, but actually, there are many pixel regions).

Each sub-pixel region in the same pixel region is distributed along the long side direction of the display panel. Specifically, the red sub-pixel region R, the green sub-pixel region G, and the blue sub-pixel region B are distributed along the long side direction of the display panel, so that each sub-pixel region in the same pixel region is provided with a gate voltage Vselection through the same scanning line 11, and meanwhile is provided with a data signal Vdata and a driving power signal Vdd through the plurality of data lines 12 and the plurality of power lines 13, to further adapt to the wiring manner of the existing display panel.

The application is not limited thereto. Each sub-pixel region in the same pixel region may also be distributed along the short side direction of the display panel. At this time, a plurality of scanning lines 11 (the number of scanning lines 11 is the same as the number of sub-pixel regions) provide a gate voltage Vselection to each sub-pixel region in the same pixel region. Meanwhile, one data line 12 and one power line 13 provide a data signal Vdata and a driving power signal Vdd to each sub-pixel region in the same pixel region.

In the embodiment, a plurality of the power lines 13 and a plurality of the data lines 12 are alternately arranged at intervals to facilitate circuit wiring. Of course, the application is not limited thereto, and a plurality of the power lines 13 and a plurality of the data lines 12 may not be alternately arranged spaced apart.

The light-emitting module 14 includes a driving circuit structure 141 and a unit light-emitting device 142 driven by the driving circuit structure 141.

In the present embodiment, taking the driving circuit structure 141 with a 2T1C structure as an example, but the application is not limited thereto. The driving circuit structure 141 with a 2T1C structure includes a switching transistor 1411, a driving transistor 1412, a storage capacitor 1413. The gate, the source, and the drain of the switching transistor 1411 are electrically connected to the scanning line 11, the data line 12, and the gate of the driving transistor 1412, respectively. The source and the drain of the driving transistor 1412 are electrically connected to the power line 13 and the unit light-emitting device 142, respectively. One end of the storage capacitor 1413 is electrically connected to the gate of the driving transistor 1412, and the other end thereof is electrically connected to the source of the light-emitting module 1412. The application is not limited thereto. In other embodiments, the other end of the storage capacitor 1413 may be further electrically connected to the drain of the driving transistor 1412.

When the light-emitting module 14 operates, the gate of the switching transistor 1411 is turned on when the switching transistor 1411 is gated by the scanning signal, and the data signal Vdata is introduced by the source thereof, thereby charging the storage capacitor 1413 through the drain of the switching transistor 1411. The storage capacitor 1413 maintains the stabilization of the gate voltage of the driving transistor 1412 for one frame of time. The driving transistor 1412 generally operates in a saturation region, and supplies the driving current for the unit emitting device 142 through the drain.

The display panel of the embodiment is an organic light-emitting display panel. Of course, the application is not limited thereto, and the display panel may be other types, such as a liquid crystal display panel.

The signal access part 15 supplies the power signal to the scanning lines 11, the data lines 12, and the power lines 13. In this embodiment, since the data lines 12 and the power lines 13 extend along the short side direction of the display panel 1, and the number of the data lines 12 and the power lines 13 are large, thus, the signal access part 15 is arranged at the long side of the display panel 1 to facilitate the wiring setting. Of course, the application is not limited thereto. The signal access part 15 may also be located at the short side of the display panel 1 on the premise that the wiring is properly arranged. Such sides are not limited to one side of the short sides or the long sides, and power may be supplied simultaneously on both sides. When the display panel of the application is a flexible display panel, the signal access part 15 can also be bent to a back of the display panel 1 (i.e., the side without a display window), thereby reducing the size of the frame.

In summary, compared with power lines extending along the long side direction of the display panel, a plurality of power lines of the display panel provided by the application extend along the short side direction of the display panel, which effectively shortens the length of the power line and improves the display unevenness caused by the resistance voltage drop on the power line.

The objects, technical solutions and beneficial effects of the application are further explained by the specific examples described above. It should be understood that the above description is only the specific embodiment of the application, and is not intended to limit the application in any form. Any modification, equivalent replacement, improvement, etc. made within the spirit and principles of the present application shall be included in the protection scope of the present application.

What is claimed is:

1. A display panel, comprising:
a light-emitting module,
one or more scanning lines,
one or more data lines, and
a plurality of power lines electrically connected to the light-emitting module, each of the power lines extending along a short side direction of the display panel, and the plurality of the power lines being arranged at intervals along a long side direction of the display panel.

2. The display panel according to claim 1, wherein there are a plurality of the data lines and a plurality of scanning lines on the display panel, each of the data lines extends along a short side direction of the display panel, and a plurality of the data lines are arranged at intervals along the long side direction of the display panel.

3. The display panel according to claim 2, wherein each of the scanning lines extends along the long side direction of the display panel, and a plurality of the scanning lines are arranged at intervals along the short side direction of the display panel.

4. The display panel according to claim 1, wherein the power lines and the data lines are arranged in a same layer and are insulated from each other.

5. The display panel according to claim 4, wherein the plurality of the power lines and the plurality of the data lines are alternately arranged at intervals.

6. The display panel according to claim 1, wherein a plurality of the scanning lines intersect with a plurality of the data lines and a plurality of the power lines to define sub-pixel regions with various colors, and one data line and one power line are simultaneously arranged between the adjacent two sub-pixel regions.

7. The display panel according to claim 1, further comprising:
a signal access part located at an edge of the long side of the display panel.

8. The display panel according to claim 1, further comprising:
a signal access part, wherein the display panel is a flexible display panel, and the signal access part is located on a back of the display panel.

9. A terminal, comprising:
a housing and the display panel according to claim 1 arranged in the housing.
